(19) United States
(12) Patent Application Publication
(10) Pub. No.: US 2026/0010600 A1
(43) Pub. Date: Jan. 8, 2026

(54) ELECTRONIC DEVICES AND METHODS OF OPERATION THEREOF

(71) Applicant: LG ELECTRONICS INC., Seoul (KR)

(72) Inventors: Eunkyung JUNG, Seoul (KR); Sangseok LEE, Seoul (KR)

(73) Assignee: LG ELECTRONICS INC., Seoul (KR)

(21) Appl. No.: 18/942,237

(22) Filed: Nov. 8, 2024

(30) Foreign Application Priority Data
Jul. 4, 2024 (WO) PCT/KR2024/009512

(51) Int. Cl. G06F 21/32; G06F 3/16

(52) U.S. Cl. CPC G06F 21/32; G06F 3/167; G06F 2221/2117

(57) ABSTRACT

An electronic device according to an embodiment of the present disclosure may comprise a memory; and a controller configured to: generate one or more speech groups using voice data collected from one or more users, receive a voice command, obtain a speech group matching the voice command among the one or more speech groups, and when there is an account profile that matches speech group information of the obtained speech group among a plurality of account profiles stored in the memory, match the account profile and the speech group information to store the matched account profile and speech group information in memory.

### CROSS-REFERENCE TO RELATED APPLICATION(S)

Pursuant to 35 U.S.C. § 119, this application claims the benefit of earlier filing date and right of priority to International Application No(s). PCT/KR2024/009512, filed on Jul. 4, 2024, the contents of which are all incorporated by reference herein in their entirety.

### BACKGROUND OF THE INVENTION

### 1. Field of the Invention

This disclosure relates to an electronic device, and more specifically, to the electronic device capable of providing voice print recognition service.

### 2. Discussion of the Related Art

Recent display device provide a voice recognition service that provides various services through the voice uttered by the user. An example of the voice recognition service is a voiceprint recognition service that registers a voiceprint corresponding to the voice uttered by the user to an account.

The display device displays a plurality of sentences for voiceprint registration, and the user utters voices corresponding to the plurality of sentences. Afterwards, voice features are extracted from the voices uttered by the user, and then a voiceprint registration process is performed in which the extracted voice features are matched to the account.

However, since the user must utter voices corresponding to a plurality of sentences, the user may feel uncomfortable during the voiceprint registration process.

Additionally, there is a problem in that it cannot be confirmed whether the user whose account is currently logged in to the display device and a speaker for voiceprint registration are the same. If the user of the account logged in to the display device and the speaker for voiceprint registration are not the same, the speaker who performed voiceprint registration may use information about the logged in account, which may cause security problem.

### SUMMARY OF THE INVENTION

The purpose of the present disclosure may be to provide a display device that easily performs a voiceprint registration process without a separate speech process for a voiceprint registration.

The purpose of the present disclosure may be to match the user of the account logged into the display device with the speaker for voiceprint registration.

The purpose of the present disclosure may be to automatically provide a voiceprint registration service by generating a speech group that may identify the speaker based on collected voice data.

An electronic device according to an embodiment of the present disclosure may comprise a memory; and a controller configured to: generate one or more speech groups using voice data collected from one or more users, receive a voice command, obtain a speech group matching the voice command among the one or more speech groups, and when there is an account profile that matches speech group information of the obtained speech group among a plurality of account profiles stored in the memory, match the account profile and the speech group information to store the matched account profile and speech group information in memory.

A method of operating an electronic device according to an embodiment of the present disclosure may comprise generating one or more speech groups using voice data collected from one or more users; receiving a voice command; obtaining a speech group matching the voice command among the one or more speech groups; and when there is an account profile that matches speech group information of the obtained speech group among a plurality of account profiles, matching the account profile and the speech group information to store the matched account profile and speech group information.

According to an embodiment of the present disclosure, the inconvenience of the voiceprint registration process may be eliminated as the voiceprint registration process is performed without a separate speech process for the voiceprint registration.

According to an embodiment of the present disclosure, the user of the account logged in to the display device and the speaker for the voiceprint registration are matched, so that an error in information between the speaker and the account logged in to the display device may be reduced.

According to an embodiment of the present disclosure, the voiceprint registration service may be automatically induced by generating a speech group capable of identifying the speaker based on collected voice data. Accordingly, the process for the voiceprint registration may be simplified.

### BRIEF DESCRIPTION OF THE DRAWINGS

FIG. 1 is a block diagram illustrating a configuration of a display device according to an embodiment of the present disclosure.

FIG. 2 is a block diagram of a remote control device according to an embodiment of the present disclosure.

FIG. 3 shows an example of an actual configuration of a remote control device according to an embodiment of the present disclosure.

FIG. 4 shows an example of using a remote control device according to an embodiment of the present disclosure.

FIG. 5 shows an artificial intelligence (AI) server according to an embodiment of the present disclosure.

FIG. 6 is a diagram for explaining the configuration of a system according to an embodiment of the present disclosure.

FIG. 7 is a flowchart illustrating a method of operating a display device according to an embodiment of the present disclosure.

FIG. 8 is a diagram illustrating a process for generating one or more speech groups using spoken voices according to an embodiment of the present disclosure.

FIG. 9 is a diagram illustrating an example of displaying a voiceprint registration window according to an embodiment of the present disclosure.

FIG. 10 is a diagram illustrating an example of displaying a voiceprint registration completion notification according to an embodiment of the present disclosure.

FIGS. 11A to 11D are diagrams for explaining an embodiment related to the present disclosure.

FIG. 12 is a sequence diagram for explaining a method of operating a system according to an embodiment of the present disclosure.

FIG. 13 is a diagram explaining the process of updating the speech group and a voiceprint recognition model after completing voiceprint registration.

### DETAILED DESCRIPTION OF THE PREFERRED EMBODIMENTS

Hereinafter, the present disclosure will be described in more detail with reference to the drawings.

Hereinafter, embodiments of the present disclosure will be described in detail with reference to the drawings. The suffixes “module” and “unit or portion” for components used in the following description are merely provided only for facilitation of preparing this specification, and thus they are not granted a specific meaning or function.

The display device according to an embodiment of the present disclosure is, for example, an intelligent display device in which a computer support function is added to a broadcast reception function, and is faithful to a broadcast reception function and has an Internet function added thereto, such as a handwritten input device, a touch screen Alternatively, a more user-friendly interface such as a spatial remote control may be provided. In addition, it is connected to the Internet and a computer with the support of a wired or wireless Internet function, so that functions such as e-mail, web browsing, banking, or games may also be performed. A standardized general-purpose OS may be used for these various functions.

Accordingly, in the display device described in the present disclosure, various user-friendly functions may be performed because various applications may be freely added or deleted, for example, on a general-purpose OS kernel. More specifically, the display device may be, for example, a network TV, HBBTV, smart TV, LED TV, OLED TV, and the like, and may be applied to a smart phone in some cases.

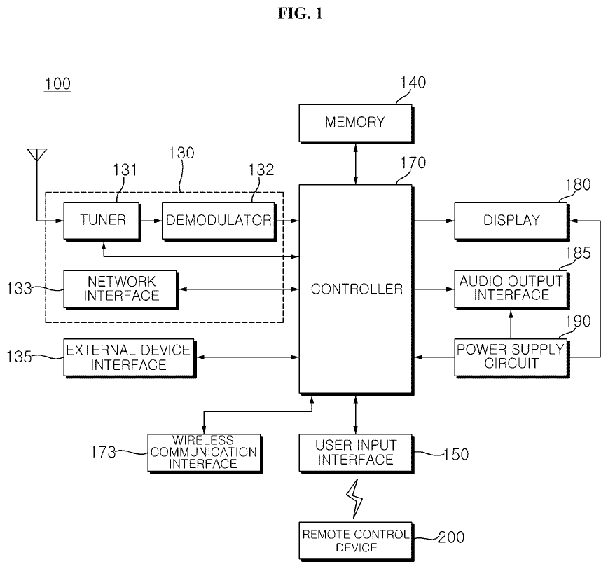

FIG. 1 is a block diagram showing a configuration of a display device according to an embodiment of the present disclosure.

Referring to FIG. 1, a display device 100 may include a broadcast receiver 130, an external device interface 135, a memory 140, a user input interface 150, a controller 170, a wireless communication interface 173, a display 180, a speaker 185, and a power supply circuit 190.

The broadcast receiving unit 130 may include a tuner 131, a demodulator 132, and a network interface 133.

The tuner 131 may select a specific broadcast channel according to a channel selection command. The tuner 131 may receive a broadcast signal for the selected specific broadcast channel.

The demodulator 132 may separate the received broadcast signal into an image signal, an audio signal, and a data signal related to a broadcast program, and restore the separated image signal, audio signal, and data signal to a format capable of being output.

The external device interface 135 may receive an application or a list of applications in an external device adjacent thereto, and transmit the same to the controller 170 or the memory 140.

The external device interface 135 may provide a connection path between the display device 100 and an external device. The external device interface 135 may receive one or more of images and audio output from an external device connected to the display device 100 in a wired or wireless manner, and transmit the same to the controller 170. The external device interface 135 may include a plurality of external input terminals. The plurality of external input terminals may include an RGB terminal, one or more High Definition Multimedia Interface (HDMI) terminals, and a element terminal.

The image signal of the external device input through the external device interface unit 135 may be output through the display 180. The audio signal of the external device input through the external device interface 135 may be output through the speaker 185.

The external device connectable to the external device interface 135 may be any one of a set-top box, a Blu-ray player, a DVD player, a game machine, a sound bar, a smartphone, a PC, a USB memory, and a home theater, but this is only an example.

The network interface 133 may provide an interface for connecting the display device 100 to a wired/wireless network including an Internet network. The network interface 133 may transmit or receive data to or from other users or other electronic devices through a connected network or another network linked to the connected network.

In addition, a part of content data stored in the display device 100 may be transmitted to a selected user among a selected user or a selected electronic device among other users or other electronic devices registered in advance in the display device 100.

The network interface 133 may access a predetermined web page through the connected network or the other network linked to the connected network. That is, it is possible to access a predetermined web page through a network, and transmit or receive data to or from a corresponding server.

In addition, the network interface 133 may receive content or data provided by a content provider or a network operator. That is, the network interface 133 may receive content such as movies, advertisements, games, VOD, and broadcast signals and information related thereto provided from a content provider or a network provider through a network.

In addition, the network interface 133 may receive update information and update files of firmware provided by the network operator, and may transmit data to an Internet or content provider or a network operator.

The network interface 133 may select and receive a desired application from among applications that are open to the public through a network.

The memory 140 may store programs for signal processing and control of the controller 170, and may store images, audio, or data signals, which have been subjected to signal-processed.

In addition, the memory 140 may perform a function for temporarily storing images, audio, or data signals input from an external device interface 135 or the network interface 133, and store information on a predetermined image through a channel storage function.

The memory 140 may store an application or a list of applications input from the external device interface 135 or the network interface 133.

The display device 100 may play back a content file (a moving image file, a still image file, a music file, a document file, an application file, or the like) stored in the memory 140 and provide the same to the user.

The user input interface 150 may transmit a signal input by the user to the controller 170 or a signal from the controller 170 to the user. For example, the user input interface 150 may receive and process a control signal such as power on/off, channel selection, screen settings, and the like from the remote control device 200 in accordance with various communication methods, such as a Bluetooth communication method, a WB (Ultra Wideband) communication method, a ZigBee communication method, an RF (Radio Frequency) communication method, or an infrared (IR) communication method or may perform processing to transmit the control signal from the controller 170 to the remote control device 200.

In addition, the user input interface 150 may transmit a control signal input from a local key (not shown) such as a power key, a channel key, a volume key, and a setting value to the controller 170.

The image signal image-processed by the controller 170 may be input to the display 180 and displayed as an image corresponding to a corresponding image signal. Also, the image signal image-processed by the controller 170 may be input to an external output device through the external device interface 135.

The audio signal processed by the controller 170 may be output to the speaker 185. Also, the audio signal processed by the controller 170 may be input to the external output device through the external device interface 135.

In addition, the controller 170 may control the overall operation of the display device 100.

In addition, the controller 170 may control the display device 100 by a user command input through the user input interface 150 or an internal program and connect to a network to download an application a list of applications or applications desired by the user to the display device 100.

The controller 170 may allow the channel information or the like selected by the user to be output through the display 180 or the speaker 185 along with the processed image or audio signal.

In addition, the controller 170 may output an image signal or an audio signal through the display 180 or the speaker 185, according to a command for playing back an image of an external device through the user input interface 150, the image signal or the audio signal being input from an external device, for example, a camera or a camcorder, through the external device interface 135.

Meanwhile, the controller 170 may allow the display 180 to display an image, for example, allow a broadcast image which is input through the tuner 131 or an external input image which is input through the external device interface 135, an image which is input through the network interface unit or an image which is stored in the memory 140 to be displayed on the display 180. In this case, an image being displayed on the display 180 may be a still image or a moving image, and may be a 2D image or a 3D image.

In addition, the controller 170 may allow content stored in the display device 100, received broadcast content, or external input content input from the outside to be played back, and the content may have various forms such as a broadcast image, an external input image, an audio file, still images, accessed web screens, and document files.

The wireless communication interface 173 may communicate with an external device through wired or wireless communication. The wireless communication interface 173 may perform short range communication with an external device. To this end, the wireless communication interface 173 may support short range communication using at least one of Bluetooth™, Radio Frequency Identification (RFID), Infrared Data Association (IrDA), Ultra Wideband (UWB), ZigBee, Near Field Communication (NFC), Wi-Fi (Wireless-Fidelity), Wi-Fi (Wireless-Fidelity), Wi-Fi Direct, and Wireless USB (Wireless Universal Serial Bus) technologies. The wireless communication interface 173 may support wireless communication between the display device 100 and a wireless communication system, between the display device 100 and another display device 100, or between the display device 100 and a network in which the display device 100 (or an external server) is located through wireless area networks. The wireless area networks may be wireless personal area networks.

Here, the another display device 100 may be a wearable device (e.g., a smartwatch, smart glasses or a head mounted display (HMD), a mobile terminal such as a smart phone, which is able to exchange data (or interwork) with the display device 100 according to the present disclosure. The wireless communication interface 173 may detect (or recognize) a wearable device capable of communication around the display device 100.

Furthermore, when the detected wearable device is an authenticated device to communicate with the display device 100 according to the present disclosure, the controller 170 may transmit at least a portion of data processed by the display device 100 to the wearable device through the wireless communication interface 173. Therefore, a user of the wearable device may use data processed by the display device 100 through the wearable device.

The display 180 may convert image signals, data signals, and OSD signals processed by the controller 170, or image signals or data signals received from the external device interface 135 into R, G, and B signals, and generate drive signals.

Meanwhile, since the display device 100 shown in FIG. 1 is only an embodiment of the present disclosure, some of the illustrated components may be integrated, added, or omitted depending on the specification of the display device 100 that is actually implemented.

That is, two or more components may be combined into one component, or one element may be divided into two or more components as necessary. In addition, a function performed in each block is for describing an embodiment of the present disclosure, and its specific operation or device does not limit the scope of the present disclosure.

According to another embodiment of the present disclosure, unlike the display device 100 shown in FIG. 1, the display device 100 may receive an image through the network interface 133 or the external device interface 135 without a tuner 131 and a demodulator 132 and play back the same.

For example, the display device 100 may be divided into an image processing device, such as a set-top box, for receiving broadcast signals or content according to various network services, and a content playback device that plays back content input from the image processing device.

In this case, an operation method of the display device according to an embodiment of the present disclosure will be described below may be implemented by not only the display device 100 as described with reference to FIG. 1 and but also one of an image processing device such as the separated set-top box and a content playback device including the display 180 the speaker 185.

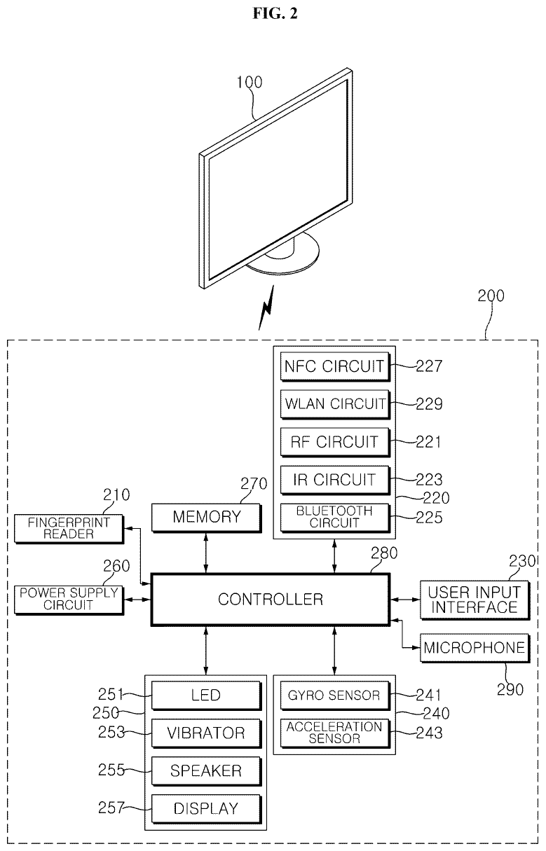

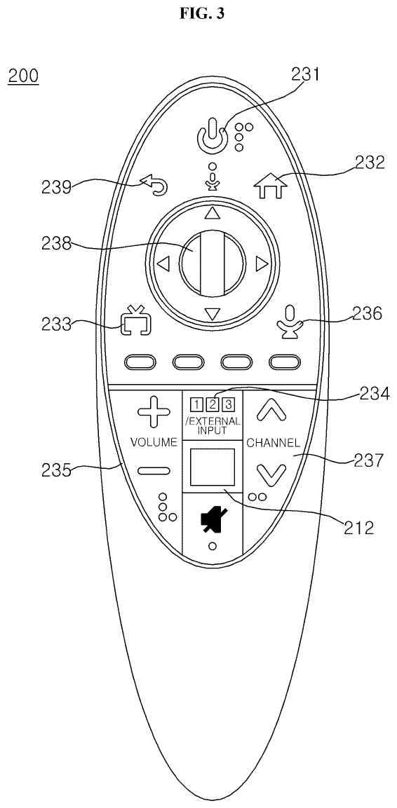

Next, a remote control device according to an embodiment of the present disclosure will be described with reference to FIGS. 2 to 3.

FIG. 2 is a block diagram of a remote control device according to an embodiment of the present disclosure, and FIG. 3 shows an actual configuration example of a remote control device 200 according to an embodiment of the present disclosure.

First, referring to FIG. 2, the remote control device 200 may include a fingerprint reader 210, a wireless communication circuit 220, a user input interface 230, a sensor 240, an output interface 250, a power supply circuit 260, a memory 270, a controller 280, and a microphone 290.

Referring to FIG. 2, the wireless communication circuit 220 may transmit and receive signals to and from any one of display devices according to embodiments of the present disclosure described above.

The remote control device 200 may include an RF circuit 221 capable of transmitting and receiving signals to and from the display device 100 according to the RF communication standard, and an IR circuit 223 capable of transmitting and receiving signals to and from the display device 100 according to the IR communication standard. In addition, the remote control device 200 may include a Bluetooth circuit 225 capable of transmitting and receiving signals to and from the display device 100 according to the Bluetooth communication standard. In addition, the remote control device 200 may include an NFC circuit 227 capable of transmitting and receiving signals to and from the display device 100 according to the NFC (near field communication) communication standard, and a WLAN circuit 229 capable of transmitting and receiving signals to and from the display device 100 according to the wireless LAN (WLAN) communication standard.

In addition, the remote control device 200 may transmit a signal containing information on the movement of the remote control device 200 to the display device 100 through the wireless communication circuit 220.

In addition, the remote control device 200 may receive a signal transmitted by the display device 100 through the RF circuit 221, and transmit a command regarding power on/off, channel change, volume adjustment, or the like to the display device 100 through the IR circuit 223 as necessary.

The user input interface 230 may include a keypad, a button, a touch pad, a touch screen, or the like. The user may input a command related to the display device 100 to the remote control device 200 by operating the user input interface 230. When the user input interface 230 includes a hard key button, the user may input a command related to the display device 100 to the remote control device 200 through a push operation of the hard key button. Details will be described with reference to FIG. 3.

Referring to FIG. 3, the remote control device 200 may include a plurality of buttons. The plurality of buttons may include a fingerprint recognition button 212, a power button 231, a home button 232, a live button 233, an external input button 234, a volume control button 235, a voice recognition button 236, a channel change button 237, an OK button 238, and a back-play button 239.

The fingerprint recognition button 212 may be a button for recognizing a user's fingerprint. In one embodiment, the fingerprint recognition button 212 may enable a push operation, and thus may receive a push operation and a fingerprint recognition operation.

The power button 231 may be a button for turning on/off the power of the display device 100.

The home button 232 may be a button for moving to the home screen of the display device 100.

The live button 233 may be a button for displaying a real-time broadcast program.

The external input button 234 may be a button for receiving an external input connected to the display device 100.

The volume control button 235 may be a button for adjusting the level of the volume output by the display device 100.

The voice recognition button 236 may be a button for receiving a user's voice and recognizing the received voice.

The channel change button 237 may be a button for receiving a broadcast signal of a specific broadcast channel.

The OK button 238 may be a button for selecting a specific function, and the back-play button 239 may be a button for returning to a previous screen.

A description will be given referring again to FIG. 2.

When the user input interface 230 includes a touch screen, the user may input a command related to the display device 100 to the remote control device 200 by touching a soft key of the touch screen. In addition, the user input interface 230 may include various types of input means that may be operated by a user, such as a scroll key or a jog key, and the present embodiment does not limit the scope of the present disclosure.

The sensor 240 may include a gyro sensor 241 or an acceleration sensor 243, and the gyro sensor 241 may sense information regarding the movement of the remote control device 200.

For example, the gyro sensor 241 may sense information about the operation of the remote control device 200 based on the x, y, and z axes, and the acceleration sensor 243 may sense information about the moving speed of the remote control device 200. Meanwhile, the remote control device 200 may further include a distance measuring sensor to sense the distance between the display device 100 and the display 180.

The output interface 250 may output an image or audio signal corresponding to the operation of the user input interface 230 or a signal transmitted from the display device 100.

The user may recognize whether the user input interface 230 is operated or whether the display device 100 is controlled through the output interface 250.

For example, the output interface 450 may include an LED 251 that emits light, a vibrator 253 that generates vibration, a speaker 255 that outputs sound, or a display 257 that outputs an image when the user input interface 230 is operated or a signal is transmitted and received to and from the display device 100 through the wireless communication interface 225.

In addition, the power supply circuit 260 may supply power to the remote control device 200, and stop power supply when the remote control device 200 has not moved for a predetermined time to reduce power consumption.

The power supply circuit 260 may restart power supply when a predetermined key provided in the remote control device 200 is operated.

The memory 270 may store various types of programs and application data required for control or operation of the remote control device 200.

When the remote control device 200 transmits and receives signals wirelessly through the display device 100 and the RF circuit 221, the remote control device 200 and the display device 100 transmit and receive signals through a predetermined frequency band.

The controller 280 of the remote control device 200 may store and refer to information on a frequency band capable of wirelessly transmitting and receiving signals to and from the display device 100 paired with the remote control device 200 in the memory 270.

The controller 280 may control all matters related to the control of the remote control device 200. The controller 280 may transmit a signal corresponding to a predetermined key operation of the user input interface 230 or a signal corresponding to the movement of the remote control device 200 sensed by the sensor 240 through the wireless communication interface 225.

Also, the microphone 290 of the remote control device 200 may obtain a speech.

A plurality of microphones 290 may be provided.

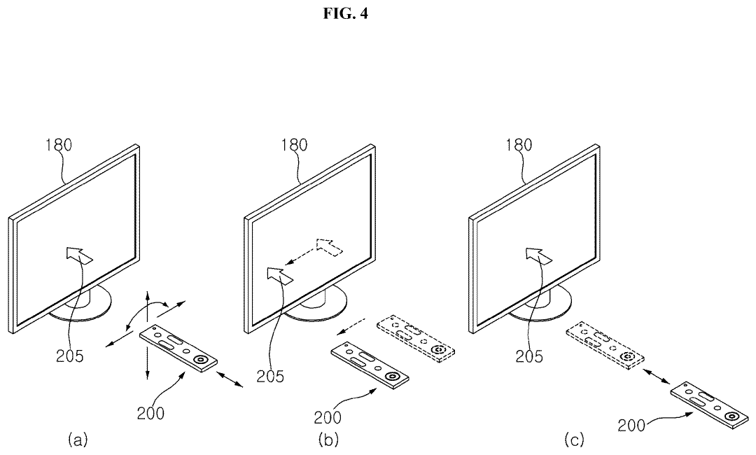

Next, a description will be given referring to FIG. 4.

FIG. 4 shows an example of using a remote control device according to an embodiment of the present disclosure.

In FIG. 4, (a) illustrates that a pointer 205 corresponding to the remote control device 200 is displayed on the display 180.

The user may move or rotate the remote control device 200 up, down, left and right. The pointer 205 displayed on the display 180 of the display device 100 may correspond to the movement of the remote control device 200. As shown in the drawings, the pointer 205 is moved and displayed according to movement of the remote control device 200 in a 3D space, so the remote control device 200 may be called a space remote control device.

In (b) of FIG. 4, it is illustrated that that when the user moves the remote control device 200 to the left, the pointer 205 displayed on the display 180 of the display device 100 moves to the left correspondingly.

Information on the movement of the remote control device 200 detected through a sensor of the remote control device 200 is transmitted to the display device 100. The display device 100 may calculate the coordinates of the pointer 205 based on information on the movement of the remote control device 200. The display device 100 may display the pointer 205 to correspond to the calculated coordinates.

In (c) of FIG. 4, it is illustrated that a user moves the remote control device 200 away from the display 180 while pressing a specific button in the remote control device 200. Accordingly, a selected area in the display 180 corresponding to the pointer 205 may be zoomed in and displayed enlarged.

Conversely, when the user moves the remote control device 200 to be close to the display 180, the selected area in the display 180 corresponding to the pointer 205 may be zoomed out and displayed reduced.

On the other hand, when the remote control device 200 moves away from the display 180, the selected area may be zoomed out, and when the remote control device 200 moves to be close to the display 180, the selected area may be zoomed in.

Also, in a state in which a specific button in the remote control device 200 is being pressed, recognition of up, down, left, or right movements may be excluded. That is, when the remote control device 200 moves away from or close to the display 180, the up, down, left, or right movements are not recognized, and only the forward and backward movements may be recognized. In a state in which a specific button in the remote control device 200 is not being pressed, only the pointer 205 moves according to the up, down, left, or right movements of the remote control device 200.

Meanwhile, the movement speed or the movement direction of the pointer 205 may correspond to the movement speed or the movement direction of the remote control device 200.

Meanwhile, in the present specification, a pointer refers to an object displayed on the display 180 in response to an operation of the remote control device 200. Accordingly, objects of various shapes other than the arrow shape shown in the drawings are possible as the pointer 205. For example, the object may be a concept including a dot, a cursor, a prompt, a thick outline, and the like. In addition, the pointer 205 may be displayed corresponding to any one point among points on a horizontal axis and a vertical axis on the display 180, and may also be displayed corresponding to a plurality of points such as a line and a surface.

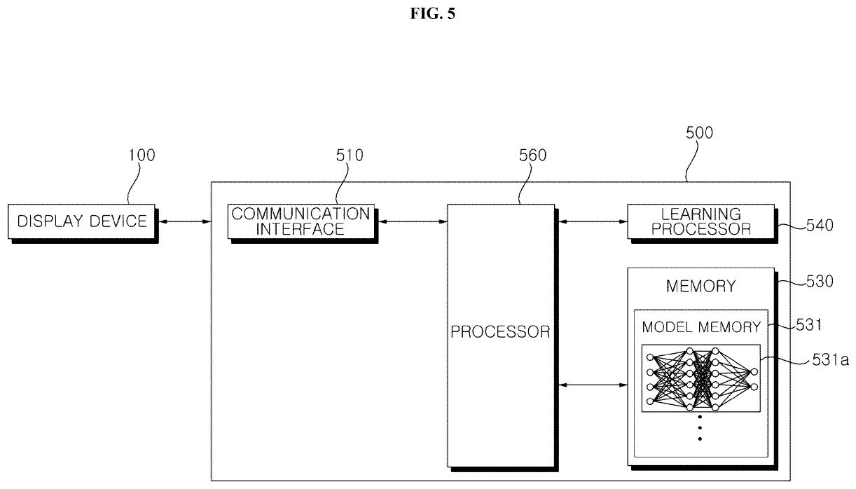

FIG. 5 shows an artificial intelligence (AI) server according to an embodiment of the present disclosure.

Referring to FIG. 5, the AI server 500 may refer to a device that trains an artificial neural network using a machine learning algorithm or uses a learned artificial neural network.

The AI server 500 may be composed of a plurality of servers to perform distributed processing, and may be defined as a 5G network.

The AI server 500 may be included as a part of the display device 100 and may perform at least part of the AI processing.

The AI server 500 may include a communication interface 510, a memory 530, a learning processor 540, and a processor 560.

The communication interface 510 may transmit and receive data with an external device such as the display device 100.

The memory 530 may include a model memory 531.

The model memory 531 may store a model (or artificial neural network, 531a) that is being trained or has been learned through the learning processor 540.

The learning processor 540 may train the artificial neural network 531a using training data. The learning model may be used while mounted on the AI server 500 of the artificial neural network, or may be mounted and used on an external device such as the display device 100.

The learning model may be implemented in hardware, software, or a combination of hardware and software. When part or all of the learning model is implemented as software, one or more instructions constituting the learning model may be stored in the memory 530.

The processor 560 may infer a result value for new input data using the learning model and generate a response or control command based on the inferred result value.

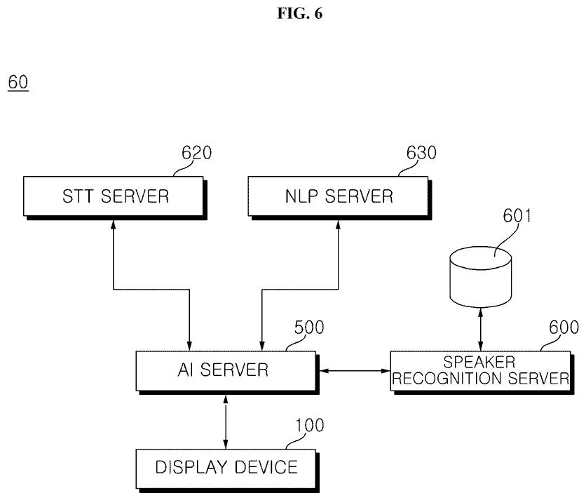

FIG. 6 is a diagram for explaining the configuration of a system according to an embodiment of the present disclosure.

Referring to FIG. 6, the system 60 may include a display device 100, an AI server 500, a Speech-To-Text (STT) server 620, a Natural Language Processing (NLP) server 630, and a speaker recognition server 600.

Each element constituting the system 60 may perform wireless communication with each other. The wireless communication may be an Internet communication.

The speaker recognition server 600 may be called a speaker recognition device. The speaker recognition server 600 may identify the speaker by comparing a voice feature of the voice signal with a pre-stored voice feature.

The AI server 500 may transmit the voice signal transmitted from the display device 100 to the speaker recognition server 600 or the STT server 620.

The AI server 500 may be a relay server that relays communication between the display device 100 and an external server.

AI server 500 may be omitted. In this case, the display device 100 may directly transmit a voice signal to the speaker recognition server 600 or the STT server 620.

The STT (Speech-To-Text) server 620 may convert a voice signal into a text data.

The STT server 620 may transmit the converted text data to the NLP server 630.

The Natural Language Processing (NLP) server 630 may obtain an intent analysis result based on text data received from the STT server 620 using a natural language processing (NLP) engine.

The NLP server 630 may transmit the obtained intention analysis result to the display device 100 through the AI server 500.

The speaker database 601 may be included in the speaker recognition server 600 or may be provided separately from the speaker recognition server 600.

The speaker database 601 may store a speaker profile corresponding to each speaker. The speaker profile may include one or more of the speaker's gender, age, nickname, payment information, email, and phone number. The speaker profile may be referred to as an account profile.

The speaker database 601 may store embedding vectors corresponding to each of a plurality of registered speakers and speaker identification information matched to each embedding vector.

The speaker profile may include an embedding vector representing the voice feature of the registered speaker.

Hereinafter, the speaker registration process may be a process of extracting features of a voice uttered by a specific speaker using voice recognition technology, matching the extracted features to speaker identification information, and storing them. The speaker registration process may be a voice print registration process.

The speaker identification process may be a process of identifying whether a pre-registered speaker matches the speaker currently speaking.

The speaker registration process and the speaker identification process may be processes for providing a personalized voice recognition service.

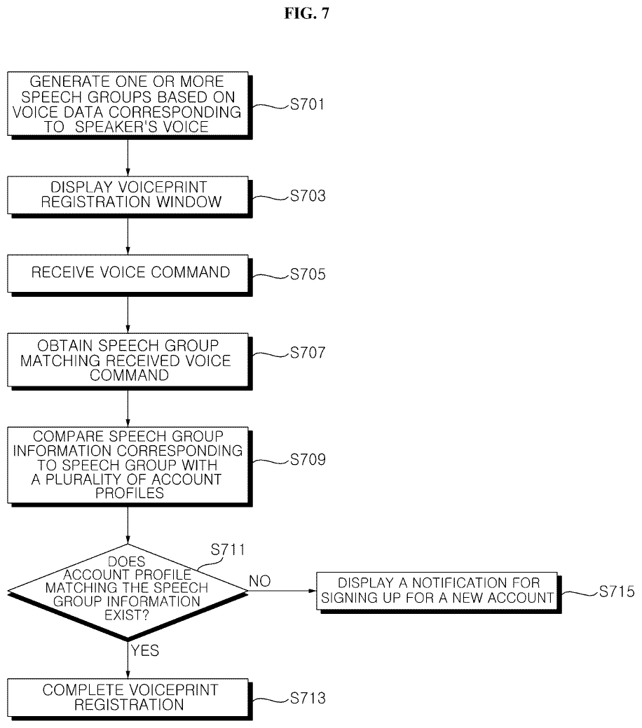

FIG. 7 is a flowchart illustrating a method of operating a display device according to an embodiment of the present disclosure.

The display device 100 below may also be applied to electronic devices equipped with a display 180. The electronic device may be any of an air conditioner, a refrigerator, a robot vacuum cleaner, or a vehicle.

The display device 100 may also be referred to as an electronic device 100.

The controller 170 of the display device 100 may generate one or more speech groups based on voice data corresponding to the speaker's voice (S701).

In one embodiment, the controller 170 may receive voices uttered by one or more speakers from the remote control device 200.

In another embodiment, the controller 170 may receive voices uttered by one or more speakers through a microphone (not shown) provided in the display device 100.

One or more speakers may utter a voice at different times. The voice may be a voice command issued to use the voice recognition service of the display 100.

The controller 170 may generate one or more speech groups based on a set of voice data corresponding to the received voice.

The controller 170 may obtain an embedding vector (voice feature vector) representing voice features from voice data. The controller 170 may extract an embedding vector from voice data using a MFCC (Mel-Frequency Cepstral Coefficients) technique.

The MFCC technique may be a technique that converts voice data into a frequency-based power spectrum and extracts an embedding vector by performing an inverse Fourier transform on the power spectrum.

The controller 170 may cluster a plurality of embedding vectors and generate one or more speech groups based on the clustering result.

The controller 170 may generate one or more speech groups by clustering a plurality of embedding vectors through a K-means clustering technique or a DBSMAY (Density-Based Spatial Clustering of Applications with Noise) technique.

The controller 170 may store an embedding vector corresponding to voice data in the memory 140. The stored embedding vectors may be used to generate the speech group.

The controller 170 may store a PCM (Pulse Code Modulation) voice file corresponding to the voice uttered by the speaker in the memory 140. The voice data may be the PCM voice file. The controller 170 may generate one or more speech groups based on the PCM voice file.

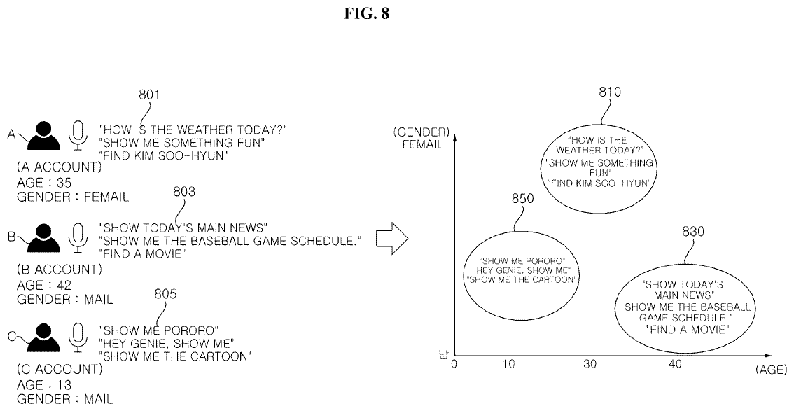

FIG. 8 is a diagram illustrating a process for generating one or more speech groups using spoken voices according to an embodiment of the present disclosure.

Referring to FIG. 8, the age of a first speaker A is 35 years old, and his gender is female. The age of a second speaker B is 42 years old, and his gender is male. The age of a third speaker C is 13 years old, and his gender is male.

The voice feature may vary depending on the age and gender of the speaker. In the present disclosure, information about voices uttered by a speaker while using the voice recognition service is collected in advance, and one or more speech groups may be generated through the collected information.

The controller 170 may extract embedding vectors from each of the voices 801 uttered by the first speaker A and generate a first speech group 810 by clustering the extracted embedding vectors.

The controller 170 may extract embedding vectors from each of the voices 803 uttered by the second speaker B and generate a second speech group 830 by clustering the extracted embedding vectors.

The controller 170 may extract embedding vectors from each of the voices 805 uttered by the third speaker C and generate a third speech group 850 by clustering the extracted embedding vectors.

Each of the first speech group 810, the second speech group 830, and the third speech group 850 may be a group clustered according to age and gender, which are items for distinguishing voice feature.

Again, FIG. 7 will be described.

When one or more speech groups are generated, the controller 170 may display a voiceprint registration window on the display 180 (S703).

In one embodiment, when one or more speech groups are generated, the controller 170 may display a voiceprint registration window for voiceprint registration on the display 180.

In another embodiment, the controller 170 may recognize the voice of a speaker who has not registered a voiceprint, and display a voiceprint registration window on the display 180 when one or more speech groups are generated.

In another embodiment, when a speaker performs the voiceprint registration through a voiceprint registration application installed on the display device 100, display of the voiceprint registration window may be omitted.

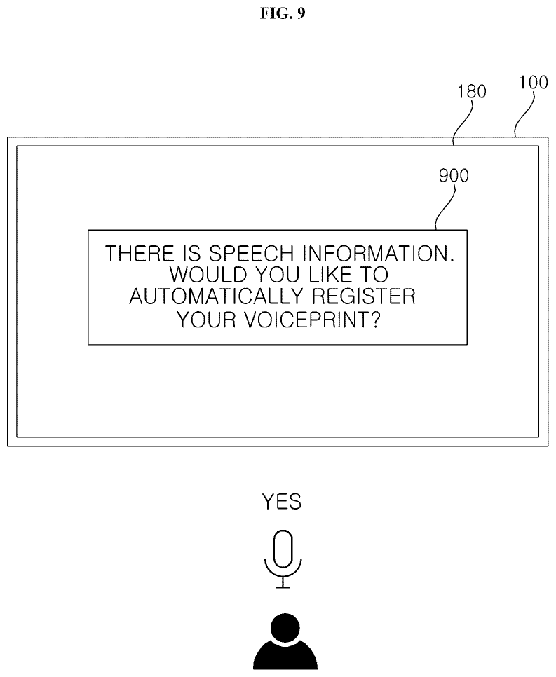

FIG. 9 is a diagram illustrating an example of displaying a voiceprint registration window according to an embodiment of the present disclosure.

Referring to FIG. 9, the controller 170 of the display device 100 may display a voiceprint registration window 900 for voiceprint registration on the display 180. The voiceprint registration window 900 may be referred to as a voiceprint registration notification.

When one or more speech groups are generated, the controller 170 may display the voiceprint registration window 900 on the display 180. The controller 170 may display the voiceprint registration window 900 when the voice of a speaker whose voiceprint is not registered is recognized and one or more speech groups are generated. The voiceprint registration window 900 may be displayed in the form of a pop-up window.

Again, FIG. 7 will be described.

The controller 170 may receive a voice command (S705) and obtain a speech group matching the received voice command among one or more speech groups (S707).

The controller 170 may receive a voice command confirming to voiceprint registration, and may extract a speech group matching the voice command from one or more speech groups according to the received voice command.

The voice command confirming to voiceprint registration may be a command indicating agreement or affirmation, such as <yes>. The controller 170 may convert the voice command into text data and recognize that the voice command is a command indicating consent through intent analysis of the converted text data.

The controller 170 may extract a voice feature vector representing a voice feature from a voice command. The controller 170 may obtain an speech group that matches the extracted voice feature vector from among one or more speech groups. The controller 170 may obtain the speech group with the closest distance between voice feature vectors among one or more speech groups as the matching speech group.

Referring to FIG. 9, the speaker utters <yes>, a voice command confirming to voiceprint registration, while the voiceprint registration window 900 is displayed on the display 180.

The controller 170 may compare speech group information corresponding to the obtained speech group with a plurality of account profiles (S709).

The speech group information may be an item that identifies an speech group. The speech group information may be items that serve as criteria for clustering the speech group. The speech group information may include one or more of an age (or age range), a gender, a first voice feature vector identifying the age, or a second voice feature vector identifying the gender.

The account profile may be a profile representing a user account logged in to the display device 100. The account profile may include one or more of the account's nickname (or name), age, gender, language, payment information (e.g., credit card information), preferred genre, or preferred content.

The account profile may be information previously registered in the account of the display device 100.

Memory 140 may store a plurality of account profiles corresponding to each of a plurality of user accounts.

The controller 170 may determine whether an account profile matching the speech group information exists among a plurality of account profiles. For example, if the age of the speech group information is in the 30s and the gender is female, the controller 170 may extract an account profile that matches this.

If it is determined that an account profile matching the speech group information exists among the plurality of account profiles (S711), the controller 170 may complete voiceprint registration (S713).

Completing voiceprint registration may be a process of matching voice features corresponding to the obtained speech group with the profile of the logged-in account and storing them in the memory 140.

In one embodiment, when the controller 170 determines that an account profile matching the speech group information exists among a plurality of account profiles, the controller may display a voiceprint registration completion notification on the display 180 indicating that voiceprint registration has been completed.

In another embodiment, the controller 170 may complete the voiceprint registration when the account profile corresponding to the account currently logged in to the display device 100 matches the speech group information corresponding to the obtained speech group.

This is because, if the voiceprint registration is made even if the user of the account currently logged in to the display device 100 and the speaker do not match, the speaker may use the information of the logged in the account, which may cause a security problem.

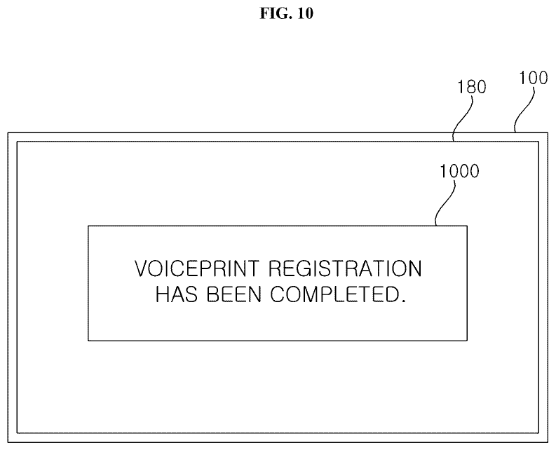

FIG. 10 is a diagram illustrating an example of displaying a voiceprint registration completion notification according to an embodiment of the present disclosure.

Referring to FIG. 10, if an account profile matching the obtained speech group information exists, the controller 170 of the display device 100 may display a voiceprint registration completion notification 1000 on the display 180.

The speaker may automatically register the voiceprint by simply uttering <yes> as shown in FIG. 9, without the hassle of uttering multiple sentences. Accordingly, the convenience of voiceprint registration may be greatly improved.

Again, FIG. 7 will be described.

If it is determined that there is no account profile matching the speech group information among the plurality of account profiles, the controller 170 may display a notification for signing up for a new account on the display 180 (S715).

If it is determined that there is no account profile matching speech group information among the plurality of account profiles, the controller 170 may display a notification for signing up for a new account on the display 180.

The notification for signing up for a new account may be a notification for matching the newly entered account profile to the speaker's speech group information.

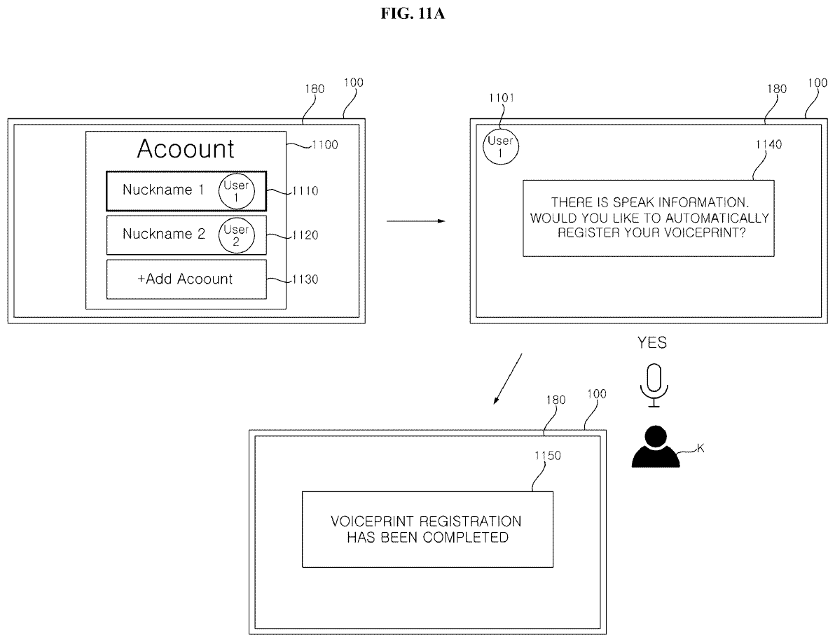

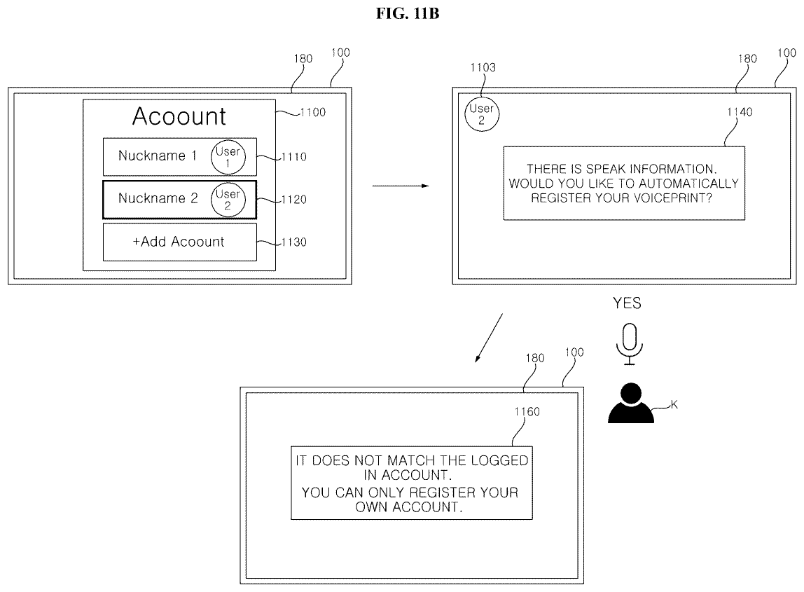

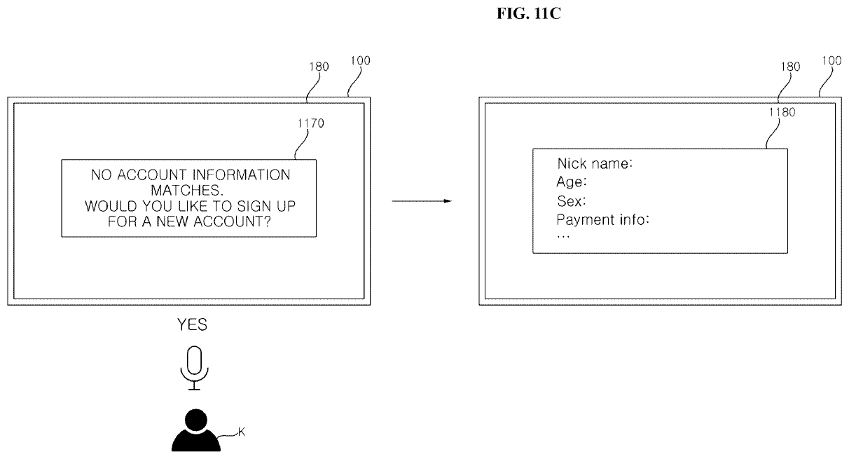

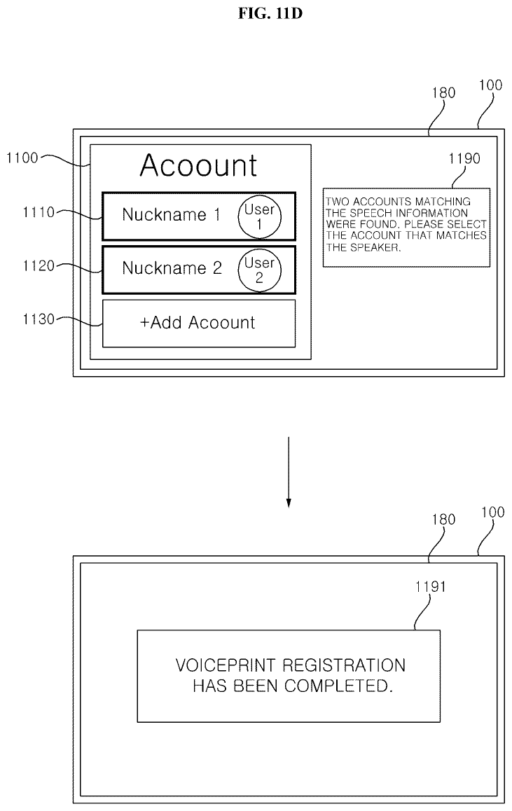

FIGS. 11A to 11D are diagrams for explaining an embodiment related to the present disclosure.

In FIGS. 11A to 11D, it is assumed that a plurality of speech groups 810, 830, and 850 are generated in advance as shown in FIG. 8.

FIG. 11A shows an example of automatically completing voiceprint registration when the profile of the logged in account matches the speech group information.

Referring to FIG. 11A, the display device 100 may display a login screen 1100 on the display 180. The login screen 1100 may include first and second account items 1110 and 1120 and an account addition item 1130.

Each of the first and second account items 1110 and 1120 may be an item indicating a previously registered account for a service of the display device 100. Each of the first and second account items 1110 and 1120 may include one or more of an account nickname or an account icon identifying the account.

The account addition item 1130 may be an item for creating a new account.

When the first account item 1110 is selected, the display device 100 may log in using the first account corresponding to the first account item 1110. The display device 100 may display a first account icon 1101 on the display 180 indicating that the user is logged in using the first account item 1110 according to the log-in process.

The first account icon 1101 may be displayed until logout. The first account icon 1101 may be displayed at the top of the screen of the display 180, but this is only an example.

In one embodiment, when one or more speech groups are generated, the display device 100 may display a voiceprint registration window 1140 on the display 180 to inquire about voiceprint registration.

In another embodiment, if the user of the first account is an unregistered voiceprint and one or more speech groups are generated, the display device 100 may display the voiceprint registration window 1140 to inquire about voiceprint registration on the display 180.

The speaker (K) utters a confirmation voice command <yes>. The display device 100 may receive the confirmation voice command and extract a voice feature vector representing a voice feature from the confirmation voice command.

The display device 100 may determine whether a speech group matching the extracted voice feature vector exists among one or more speech groups.

In one embodiment, the display device 100 may extract an speech group from a voice feature vector using an artificial neural network-based matching model stored in the memory 140.

The matching model may be an artificial intelligence model learned through a supervised learning. The learning data set for learning the matching model may include a voice feature vector for learning and an speech group label that identifies the speech group.

The matching model may be learned so that a loss function representing the difference between a target feature vector and the speech group label inferred from the voice feature vector for learning is minimized.

The display device 100 may output a voiceprint registration completion notification 1150 when an speech group that matches the extracted voice feature vector among one or more speech groups exists, and speech group information corresponding to the matched speech group matches the first account profile of the first account item 1110.

In one embodiment, a voiceprint recognition service may be provided through voiceprint registration. The voiceprint recognition service is a service that stores the voiceprint of the speaker (K), compares the voiceprint with feature of the voice uttered by the speaker (K), and performs a function to respond to the voice only when the voice feature and the voiceprint match.

The voiceprint registration may be a process of matching the account profile and the voiceprint.

FIG. 11b shows an example of outputting a notification indicating that voiceprint registration is not possible when speech group information corresponding to the voice of the speaker (K) does not match the logged in account.

Referring to FIG. 11B, the speaker (K) may log in through the second account item 1120. In fact, the user of the second account item 1120 and the speaker (K) may be different person. For example, the second account item 1120 may be an item corresponding to the a father's account, and the speaker (K) may be a son.

The display device 100 may display a second account icon 1103 on the display 180 indicating that the user is logged in using the second account item 1120 according to the log-in process.

In one embodiment, when one or more speech groups are generated, the display device 100 may display a voiceprint registration window 1140 on the display 180 to inquire about voiceprint registration.

In another embodiment, if the user of the second account is an unregistered voiceprint and one or more speech groups are generated, the display device 100 may display the voiceprint registration window 1140 on the display 180 to inquire about voiceprint registration.

The speaker (K) utters the confirmation voice command <yes>. The display device 100 may receive a confirmation voice command and extract a voice feature vector representing a voice feature from the confirmation voice command.

The display device 100 may determine whether a speech group matching the extracted voice feature vector exists among one or more speech groups.

The display device 100 may decide whether the speech group information corresponding to the matched speech group matches the second account profile of the second account item 1120 when an speech group that matches the extracted voice feature vector among one or more speech groups.

If the speech group information corresponding to the voice of the speaker K does not match the second account profile of the second account item 1120, the display device 100 may output a voiceprint registration impossibility notification 1160.

The voiceprint registration impossibility notification 1160 may be a notification indicating that the speaker and the logged-in account do not match and that the voiceprint may be registered only through the user's account.

Even if the second account profile of the second account item 1120 and the speech group information of the speaker (K) do not match, if voiceprint registration is completed, there may be a security problem that personal information (payment information) corresponding to the second account item 1120 is used by the voice of the speaker (K).

In an embodiment of the present disclosure, if speech group information matching the speaker's voice does not match the logged-in account profile, the voiceprint registration may not be permitted to prevent misuse of personal information.

In another embodiment, when the speech group information corresponding to the voice of the speaker K does not match each of the account profiles stored in the memory 140, the display device 100 may display a new account subscription notification 1170 for inducing a subscription of a new account, as shown in FIG. 11C. on the display 180.

The new account subscription notification 1170 may be displayed when there is no account profile matching the speech group information of the speaker (K).

When the display device 100 receives a confirmation voice command from the speaker K while displaying the new account subscription notification 1170, the display device 100 may display a new subscription window 1180 on the display 180.

The new subscription window 1180 may be a window for inputting an account profile including one or more of the account nickname, age, gender, or payment information.

When an account profile is input through the new subscription window 1180, the display device 100 may match the account profile with the speech group information of the speaker (K) and store the account profile with the speech group information of the speaker (K) in the memory 140.

FIG. 11D shows an implementation of displaying a selection guidance notification 1190 that induces selection of one of the plurality of account profiles when there are a plurality of account profiles matching the speech group information corresponding to the voice of the speaker (K).

Referring to FIG. 11D, when the speaker's speech group information matches the first account item 1110 and the second account item 1120, the display device 100 may display a selection guidance notification 1190 for inducing a selection of one of a plurality of account profiles on the display 180.

The display device 100 may identify each of the first account item 1110 and the second account item 1120 matching the obtained speech group through a highlight box.

When one of the first account item 1110 and the second account item 1120 is selected, the display device 100 may match the speech group information and the account profile of the selected item and store the speech group information and the account profile of the selected item.

Afterwards, the display device 100 may display a voiceprint registration completion notification 1191 on the display 180 indicating that voiceprint registration has been completed.

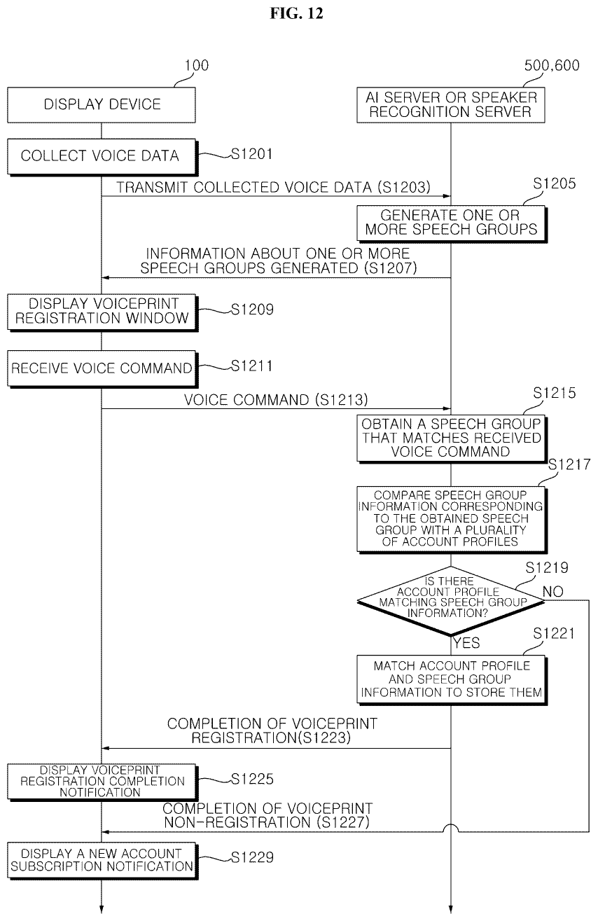

FIG. 12 is a sequence diagram for explaining a method of operating a system according to an embodiment of the present disclosure.

A system according to an embodiment of the present disclosure may include a display device 100 and an AI server 500. A system according to another embodiment of the present disclosure may include a display device 100 and a speaker recognition server 600.

That is, in FIG. 12, the server interoperating with the display device 100 may be either the AI server 500 or the speaker recognition server 600.

Hereinafter, the description will be made assuming that the server interoperating with the display device 100 is the AI server 500. However, the operations performed by the AI server 500 may be performed by the speaker recognition server 600 instead.

Referring to FIG. 12, the controller 170 of the display device 100 may collect voice data (S1201) and transmit the collected voice data to the AI server 500 through the network interface 133 (S1203).

The controller 170 may receive voices uttered by one or more speakers from the remote control device 200 or voices uttered by one or more speakers through a microphone (not shown) provided in the display device 100.

The processor 560 of the AI server 500 may generate one or more speech groups based on the received voice data (S1205).

The processor 560 may generate one or more speech groups based on speech data sets corresponding to the received speech.

The processor 560 may obtain an embedding vector (voice feature vector) representing a voice feature from voice data. The controller 170 may extract an embedding vector from the voice data using a MFCC (Mel-Frequency Cepstral Coefficients) technique.

The processor 560 may cluster a plurality of embedding vectors and generate one or more speech groups based on a clustering result.

The processor 560 may generate one or more speech groups by clustering a plurality of embedding vectors through a K-means clustering technique or a DBSMAY (Density-Based Spatial Clustering of Applications with Noise) technique.

The description of the process of generating an speech group is replaced with the embodiment of FIG. 8.

The processor 560 of the AI server 500 may transmit information about one or more speech groups generated through the communication interface 510 to the display device 100 (S1207).

Speech group information may be an item that identifies an speech group. The speech group information may be items that serve as a criteria for clustering speech groups. The speech group information may include one or more of age (or age range), gender, a voice feature vector identifying age, or a voice feature vector identifying gender.

The processor 560 may transmit speech group information for each of one or more speech groups to the display device 100 through the communication interface 510.

The controller 170 of the display device 100 may display a voiceprint registration window on the display 180 as the controller 170 receives information about one or more speech groups (S1209).

In one embodiment, when the controller 170 receives information about one or more speech groups, the controller 170 may display a voiceprint registration window for voiceprint registration on the display 180.

In another embodiment, when the controller 170 recognizes the voice of a speaker who has not registered a voiceprint and receives information about one or more speech groups, the controller 170 may display a voiceprint registration window on the display 180.

In another embodiment, when a speaker performs voiceprint registration through a voiceprint registration application installed on the display device 100, display of the voiceprint registration window may be omitted.

The controller 170 of the display device 100 may receive a voice command (S1211) and transmit the received voice command to the AI server 500 through the network interface 133 (S1213).

The controller 170 may receive a voice command confirming to voiceprint registration and transmit the received voice command to the AI server 500 through the network interface 133.

The processor 560 of the AI server 500 may obtain a speech group that matches the received voice command among one or more speech groups (S1215).

The processor 560 may extract a voice feature vector representing a voice feature from the voice command. The processor 560 may obtain an speech group that matches the extracted voice feature vector from among one or more speech groups. The processor 560 may obtain a speech group with the closest distance between voice feature vectors among one or more speech groups as a matching speech group.

The processor 560 of the AI server 500 may compare speech group information corresponding to the obtained speech group with a plurality of account profiles (S1217).

The processor 560 may previously store the plurality of account profiles in the memory 530.

When the processor 560 of the AI server 500 determines that there is an account profile matching the speech group information among the plurality of account profiles (S1219), the processor 560 may match the account profile and the speech group information to store the account profile and the speech group information in the memory 530 (S1221).

The processor 560 may complete voiceprint registration by matching the account profile and speech group information and storing them in the memory 530.

Afterwards, the processor 560 of the AI server 500 may transmit a message indicating completion of voiceprint registration to the display device 100 through the communication interface 510 (S1223).

The controller 170 of the display device 100 may display a voiceprint registration completion notification on the display 180 based on the message indicating the completion of voiceprint registration (S1225).

The voiceprint registration completion notification is the same as the embodiment of FIG. 11A.

When the processor 560 of the AI server 500 determines that there is no account profile matching the speech group information among the plurality of account profiles (S1219), the processor 560 may transmit a message indicating completion of voiceprint non-registration through the communication interface 510 to the display device 100 (S1227).

The controller 170 of the display device 100 may display a new account subscription notification on the display 180 based on the message indicating completion of voiceprint non-registration (S1229).

The new account registration notification is the same as the embodiment in FIG. 11C.

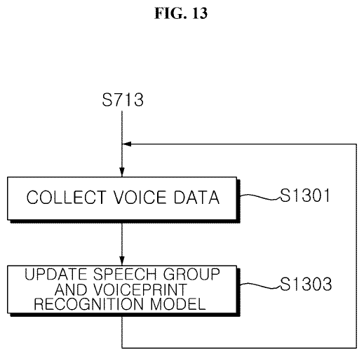

FIG. 13 is a diagram explaining the process of updating the speech group and voiceprint recognition model after completing voiceprint registration.

FIG. 13 may show operations performed after step S713 of FIG. 7.

The controller 170 of the display device 100 may collect the speaker's voice data after completing voiceprint registration (S1301).

The controller 170 may continuously collect the speaker's voice data through a microphone provided in the remote control device 200 or the display device 100.

The controller 170 may update the speech group and voiceprint recognition model based on the collected voice data (S1303).

The controller 170 may extract voice features from the speaker's voice data and generate a new speech group corresponding to the extracted voice features. The controller 170 may compare the speech group corresponding to the existing speaker with the new speech group. The controller 170 may measure a similarity between an speech group corresponding to an existing speaker and a new speech group, and if the similarity is greater than a certain similarity, the new speech group may be merged into the existing speech group.

The controller 170 may measure the similarity between the speech group corresponding to the existing speaker and the new speech group, and if the similarity is less than the certain similarity, the new speech group may be added separately from the existing speech group.

A voiceprint recognition model may be a model that recognizes a voiceprint by comparing a voice feature of voice data with a pre-stored voice feature. The voiceprint recognition model may be stored in the memory 140.

The voiceprint recognition model may be an artificial neural network-based model learned using RNN (Recurrent Neural Network).

The controller 170 may update the voiceprint recognition model using voice features of the collected voice data. The controller 170 may re-learn the voiceprint recognition model through the collected voice features. Through this process, the voiceprint recognition model may be updated, and the voiceprint recognition rate for the speaker may be improved.

The electronic device 100 according to an embodiment of the present disclosure may comprise a memory 140 and a controller 170 configured to generate one or more speech groups using voice data collected from one or more users, receive a voice command, obtain a speech group matching the voice command among the one or more speech groups, and when there is an account profile that matches speech group information of the obtained speech group among a plurality of account profiles stored in the memory, match the account profile and the speech group information to store the matched account profile and speech group information in memory.

The controller 170 may generate the one or more speech groups according to an age and a gender using the collected voice data.

The speech group information may include at least one of the age, the gender, a first voice feature vector corresponding to the age, or a second voice feature vector corresponding to the gender.

The electronic device 100 may further comprise a display 180, the controller 170 may display a voiceprint registration notification for voiceprint registration on the display when a voice of an unregistered voiceprint speaker is recognized and the one or more speech groups are generated.

The electronic device 100 may further comprise a display 180, the controller 170 may display, on the display 180, a voiceprint registration completion notification indicating that voiceprint registration has been completed.

The electronic device 100 may further comprise a display 180, the controller 170 may display a voiceprint registration impossibility notification on the display 180 when an account profile of an account logged in with the electronic device does not match the speech group information.

The electronic device 100 may further comprise a display 180, the controller 170 may display a new account subscription notification for signing up for a new account on the display 180 when an account profile of an account logged in with the electronic device does not match the speech group information.

The account profile may include an age and a gender corresponding to an account.

According to an embodiment of the present disclosure, the above-described method may be implemented with code readable by a processor on a medium in which a program is recorded. Examples of the medium readable by the processor include a ROM (Read Only Memory), a Random Access Memory (RAM), a CD-ROM, a magnetic tape, a floppy disk, an optical data storage device, and the like.

The above-described display device is not limited to the configuration and method of the above-described embodiments, but the embodiments may be configured by selectively combining all or part of each embodiment such that various modifications may be made.

What is claimed is:

1. An electronic device, comprising:
a memory; and
a controller configured to:
generate one or more speech groups using voice data collected from one or more users,
receive a voice command,
obtain a speech group matching the voice command among the one or more speech groups, and
when there is an account profile that matches speech group information of the obtained speech group among a plurality of account profiles stored in the memory, match the account profile and the speech group information to store the matched account profile and speech group information in memory.

2. The electronic device of claim 1, wherein the controller is configured to generate the one or more speech groups according to an age and a gender using the collected voice data.

3. The electronic device of claim 2, wherein the speech group information includes at least one of the age, the gender, a first voice feature vector corresponding to the age, or a second voice feature vector corresponding to the gender.

4. The electronic device of claim 1, further comprising a display,
wherein the controller is configured to display a voiceprint registration notification for voiceprint registration on the display when a voice of an unregistered voiceprint speaker is recognized and the one or more speech groups are generated.

5. The electronic device of claim 1, further comprising a display,
wherein the controller is configured to display, on the display, a voiceprint registration completion notification indicating that voiceprint registration has been completed.

6. The electronic device of claim 1, further comprising a display,
wherein the controller is configured to display a voiceprint registration impossibility notification on the display when an account profile of an account logged in with the electronic device does not match the speech group information.

7. The electronic device of claim 1, further comprising a display,
wherein the controller is configured to display a new account subscription notification for signing up for a new account on the display when an account profile of an account logged in with the electronic device does not match the speech group information.

8. The electronic device of claim 1, wherein the account profile includes an age and a gender corresponding to an account.

9. A method of operating an electronic device, comprising:
generating one or more speech groups using voice data collected from one or more users;
receiving a voice command;
obtaining a speech group matching the voice command among the one or more speech groups; and
when there is an account profile that matches speech group information of the obtained speech group among a plurality of account profiles, matching the account profile and the speech group information to store the matched account profile and speech group information.

10. The method of claim 9, wherein the generating step comprises:
generating the one or more speech groups according to an age and a gender using the collected voice data.

11. The method of claim 10, wherein the speech group information includes at least one of the age, the gender, a first voice feature vector corresponding to the age, or a second voice feature vector corresponding to the gender.

12. The method of claim 9, further comprising:
displaying a voiceprint registration notification for voiceprint registration, when a voice of an unregistered voiceprint speaker is recognized and the one or more speech groups are generated.

13. The method of claim 9, further comprising:
displaying a voiceprint registration completion notification indicating that voiceprint registration has been completed.

14. The method of claim 9, further comprising:
displaying a voiceprint registration impossibility notification when an account profile of an account logged in with the electronic device does not match the speech group information.

15. The method of claim 9, further comprising:
displaying a new account subscription notification for signing up for a new account when an account profile of an account logged in with the electronic device does not match the speech group information.
